(19) United States
(12) Patent Application Publication
(10) Pub. No.: US 2017/0095406 A1
(43) Pub. Date: Apr. 6, 2017

(54) Vibrating Oral Comfort Device and Method of Assembly

(71) Applicant: Admar International, Inc., Monroe, LA (US)

(72) Inventor: Nouri E. Hakim, Monroe, LA (US)

(73) Assignee: Admar International, Inc., Monroe, LA (US)

(21) Appl. No.: 15/282,642

(22) Filed: Sep. 30, 2016

Related U.S. Application Data
(60) Provisional application No. 62/236,624, filed on Oct. 2, 2015.

(51) Int. Cl. A61J 17/02; A61J 17/00

(52) U.S. Cl. CPC A61J 17/02; A61J 17/008

(57) ABSTRACT

A child's oral comfort device such as a teether or pacifier includes a strap, such as a wrist band, a housing removably attached to the strap, and a mouth portion fixed to the housing. The housing has a base and a removable cap. Inside the base of the housing is a printed circuit board having a sensor, a timer, a vibrator motor, a power source and a controller. When the infant applies pressure to the mouth portion, the sensor responds and sends a signal to the controller that activates the vibrator to vibrate the mouth portion for a predetermined time. The controller then prevents the vibrator from vibrating until the child reactivates the device with more pressure to start the vibrating cycle again. When the removable cap is attached, the housing and mouth portion are sealed preventing liquid from coming into contact with printed circuit board or its components. The strap, housing and mouth portion are constructed of silicone.

### CROSS REFERENCE TO RELATED APPLICATIONS

This application claims the benefit of U.S. provisional patent application Ser. No. 62/236,624, filed Oct. 2, 2015, which is incorporated herein by reference in its entirety.

### FIELD OF THE INVENTION

This invention relates generally to oral comfort devices such as teethers, teething devices and pacifiers for infants and more particularly to vibrating teething devices and pacifiers that attach to the wrist of an infant or child.

### BACKGROUND

Teething is the eruption of baby teeth through the gums. Generally speaking, baby teeth begin to erupt by around the age of six months but may start before that time. While teething is often associated with the emergence of teeth, the urge to teethe may be present in infants much earlier, even before they are born. Ultrasound images have revealed that babies suck their hands and wrists in utero as fetuses.

Many teething devices (“teethers”) are sold on the market today to provide children and infants a safe way to obtain relief from teething. Teethers are typically made of rubber, latex, silicone, or other materials that provide resilient surfaces that are hygienic and suitable for soothing the pain of teething. Teethers are often provided in the form of teething rings or other shapes (triangles, squares, etc.) such as the NUBY Kool Soother, the NUBY Easy Teethe Teether—Dinosaur, NUBY Bug-A-Loop Teether, NUBY Wacky Teether Ring, and many other products on the market today. Sometimes the teething device is mounted to a handle or hand-held component. However, these structures may be difficult for use by children who lack the ability to hold and use them in their hands, such as very young infants who have not yet acquired the coordination to manipulate hand-held objects. There is a need for teethers that can be used by children who lack the ability or coordination to manipulate the devices.

Many teethers rely solely on the tactile properties of the teether to give relief to teething children. There is a need for improved teethers that can provide greater relief than offered by traditional teethers.

Pacifiers are used to satisfy an infant's desire to suck and typically include a nipple or teat secured to a handle, often with a dividing wall, shield or face plate between them, so that the face plate can rest against the infant's skin around the mouth and is large enough to prevent the infant from swallowing the entire pacifier. The nipple or teat is typically formed of silicone, rubber, latex, or some elastomer. Pacifiers have until now generally been passive devices in that they do not provide independent motion of any kind beyond recovering from distortion of the nipple or teat arising from the infant's biting or sucking it.

It is known to add a vibrating motor to a pacifier as is described in U.S. Pat. No. 6,193,742. The disadvantages are that the device is controlled solely by a rotary switch and requires that the electronic controls be separated from the pacifier. The use of the rotary switch and the small battery size results in the need for frequent battery replacement.

An improvement for a vibrating teether is disclosed in U.S. Pat. No. 7,211,102 where the rotary switch is replaced by a pressure switch and a timer. The combination of the pressure switch and timer results in significantly fewer battery replacements. A disadvantage is that the electronics, including the battery, have to be permanently sealed or the device cannot be sanitized with water or another liquid. If the device is permanently sealed, it becomes useless once the battery dies. The vibrating teethers and pacifiers of the prior art all suffer from various deficiencies.

### SUMMARY

An oral comfort device in the form of an improved teether or pacifier includes a mechanism to provide vibration, preferably in response to activation by the child for a fixed period of time. In a preferred mode of operation, as a child begins teething or sucking, the apparatus detects that action and in response starts vibrating. The teether or pacifier may be wrist-mounted and has an exterior of the type customary to teething apparatus, that is, having a soft, compressible surface, whether smooth or irregular. The pacifier likewise has a customary teat or nipple.

Illustratively, the device includes a pressure-sensitive switch, a timer, a battery, and an electric-powered vibrator motor. Preferably these are all contained internally in the device, although in other embodiments an external switch could be employed. Various ones of these components can be integrated in a controller.

When the infant compresses a mouth portion of a device according to one embodiment, for example by biting, the switch is activated. The switch can be assisted by a sensor mechanism that may have a larger area than the switch itself so that biting need not be precisely on top of the switch in order to actuate the switch. The switch closes a circuit between an internal battery, such as a dry cell or button battery, the timer, and the vibrator motor. The vibrator vibrates until the timer times out and opens the circuit. To resume vibrating in this embodiment, the child must again actuate the switch.

In one embodiment a vibrating child's oral comfort device comprises a strap suitable for attaching to the wrist of a child; a mouth portion of a size suitable for partial or full insertion into the mouth of a child; a housing impervious to liquid having a body and a removable cap, the housing adapted to couple the mouth portion to the strap and to contain a sensor associated with the mouth portion, a removable power source, a vibrator operatively coupled to the mouth portion, and a controller having an input from the sensor and an output for driving the vibrator. In another embodiment the controller further comprises a timer for controlling the duration of operation of the vibrator. In another embodiment the sensor is a microphone. In another embodiment the strap, mouth portion and housing are constructed of silicone. In another embodiment the housing further comprises a ring adapted to receive the removable cap and a printed circuit board for mounting the sensor, the power source, the vibrator and the controller. In another embodiment the housing is removably attached to the strap. In another embodiment the mouth portion is a teether and is compressible by a user. In another embodiment the mouth portion is a teether having a textured surface. In another embodiment a face plate is fixed to the housing, and a distance between the face plate and a top of the mouth portion is less than 35 mm. In another embodiment the housing further comprises a base ring and the removable cap and base ring are constructed of nylon. In another embodiment the housing further comprises a user input adapted to receive and transmit user commands to the controller.

In another embodiment a method for assembling a child's vibrating oral comfort device comprises constructing a base ring of nylon; attaching to the base ring a printed circuit board having a sensor, a battery holder, a vibrator and a controller, molding a silicone shell and inserting the base ring into the silicone shell to form a housing; attaching a cap to the base ring; constructing a mouth portion of silicone; and fastening the mouth portion to the housing. In another embodiment the method includes a step of attaching a battery to the battery holder. In another embodiment the mouth portion is fastened to the housing with an adhesive to form a liquid tight bond. In another embodiment the housing is removably attached to a strap.

In another embodiment a child's vibrating oral comfort device comprises a housing having a base, a cap and a face plate; a mouth portion of a size suitable for partial or full insertion into the mouth of a child, the mouth portion fixed to and extending away from the housing face plate and positioned so that a child may put the mouth portion into the child's mouth; a printed circuit board fixed to the housing base and having a sensor arranged to detect pressure applied to the mouth portion, a power source holder, a vibrator operatively coupled to the mouth portion, and a controller responsively coupled to the sensor and controllingly coupled to the vibrator to control an aspect of its operation. In another embodiment the housing has an outer shell constructed of silicone and is fixed around the base leaving an opening for receiving the removable cap. In another embodiment the mouth portion is constructed of silicone. In another embodiment the sensor senses pressure. In another embodiment there is a user input adapted to receive and transmit user commands to the controller.

In some embodiments, the vibration is provided for a predetermined duration when the switch is activated by the child. In one embodiment, the teether may have multiple time settings that can be set before the teether is given to the child. In other embodiments, the switch can be a simple motion sensor. Another alternative is that the switch may turn the vibrator on, allowing it to operate according to a duty cycle, without regard to sucking or biting by the child.

It will be appreciated that the vibrator may be, but need not be, contained in the specific mouth portion of the device that enters the child's mouth. If not in that mouth portion, the vibrator is preferably mechanically coupled to the mouth portion that enters the mouth to an extent sufficient to cause vibration of the portion on which the child sucks or bites.

Furthermore, the teething device or pacifier may be mounted on a wristband so that it can be attached to a child's wrist. The wristband allows the child to bring the device to her mouth without having to grasp it with her hands. This feature allows the teether to be used by a child who is unable to grasp the device—for example, very young infants before they develop the coordination to grasp objects. It also allows the child to teethe or suck on a pacifier while retaining another object or objects in her hands. As handheld teethers are frequently dropped by children and subsequently lost, the wristband feature minimizes the likelihood of loss of or damage to the device.

In some embodiments, the wristband may be made of silicone. In some embodiments, the mouth portion may be made of silicone.

The details of one or more embodiments practicing the invention are set forth in the accompanying drawings and the description below. Other features, objects, and advantages of the invention will be apparent from the description and drawings, and from the claims.

### BRIEF DESCRIPTION OF THE DRAWINGS

FIG. 1A-1 is a front view of an oral comfort device in the form of a pacifier according to one embodiment of the present invention.

FIG. 1A-2 is a front view of an oral comfort device in the form of a pacifier according to one embodiment of the present invention.

FIG. 1B-1 and is a side view of the device of FIG. 1A-1.

FIG. 1B-2 and is a side view of the device of FIG. 1A-2.

FIG. 1C-1 is a top view of the device of FIG. 1A-1.

FIG. 1C-2 is a top view of the device of FIG. 1A-2.

FIG. 2 is a schematic view of the operational components used in an embodiment of present invention.

FIG. 3 is an alternate schematic view of operational components used in an embodiment of the present invention.

FIG. 4A is a top view an oral comfort device in the form of a teether mounted on a wristband, according to other aspects of the present invention.

FIG. 4B is a side view of the oral comfort device of FIG. 4A.

FIG. 4C is a bottom view of the oral comfort device of FIG. 4A.

FIG. 4D is an end view of the oral comfort device of FIG. 4A.

FIG. 5A is a top view of a component suitable for use in an embodiment of the oral comfort device of the present invention.

FIG. 5B is a cross sectional view of the component shown in FIG. 5A along the line X-X.

FIG. 6 is an exploded perspective view useful in illustrating a method for assembling an embodiment of the oral comfort device of the present invention.

### DETAILED DESCRIPTION OF PREFERRED EMBODIMENTS

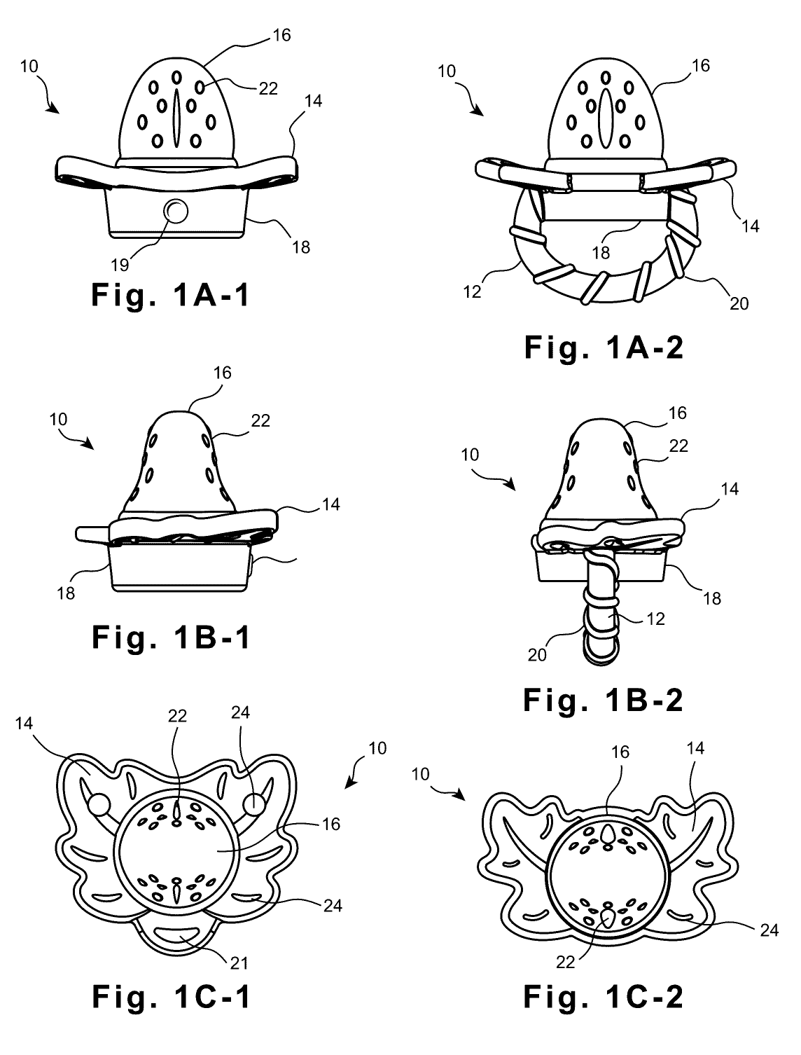

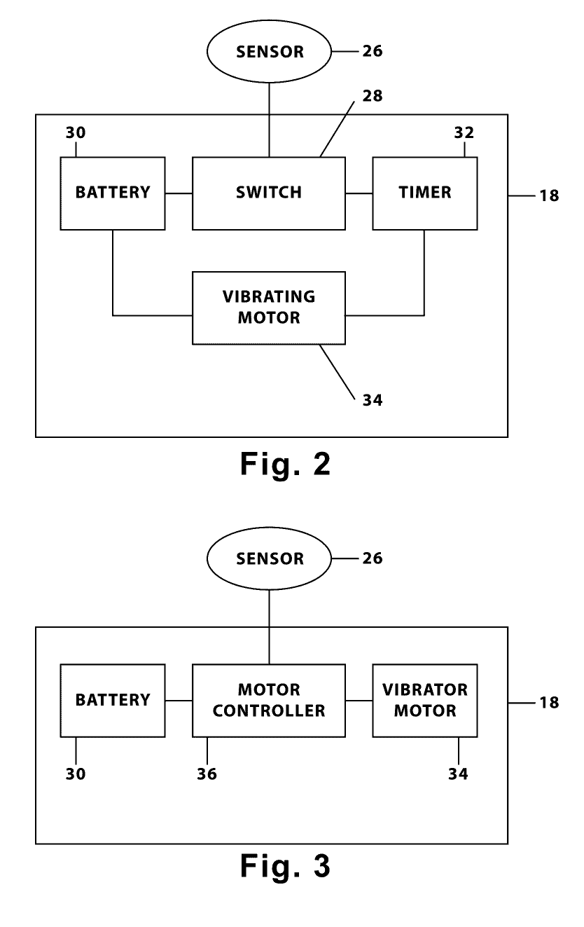

FIGS. 1A-1, 1B-1, and 1C-1 show front, side and top views of an illustrative pacifier 10 that embodies aspects of the present invention. FIGS. 1A-2, 1B-2, and 1C-2 show front, side and top views of an illustrative pacifier 10 that embodies alternative aspects of the present invention. These figures are meant to be illustrative only, as the invention can be embodied in a wide variety of physical forms according to the preference of the manufacturer. Broadly speaking, the pacifier 10 may include an optional handle 12, a barrier or faceplate 14, and a bulbous mouth portion 16. Each of these portions may be ornamented or not, as desired. In the embodiment shown here, a housing 18 is also shown, and it may be located beneath the face plate 14, generally at an inside end of handle 12 in an alternative embodiment.

Handle 12, if employed, should have a size suitable for an infant who is in need of a pacifier to grasp. It may be ornamented with a rope 20 that wraps around the handle. Preferably rope 20 is molded as part of the handle structure so that it is not separable from it.

The bulbous mouth portion 16 may be a nipple or teat. It may contain ornamentation which may also be functional. It may take various shapes, as discussed below. In this particular embodiment, as shown in FIGS. 1A-1, 1A-2, 1B-1, 1B-2, 1C-1 and 1C-2, a series of upstanding ridges 22 extend outward from mouth portion 16. They may be divided into four quadrants, each having a pie-shape or being a section of a circle. In an embodiment shown in the provisional application incorporated by reference, there are four quadrants or sectors on one side of the mouth portion 16 and four similar sectors on the opposite side of the mouth portion 16. Each quadrant contains three ridges 22 which converge near the innermost portion of the quadrant and extend readily outward. They may have any shape and extend in any direction, and numerous shapes and textures are well known to the pacifier and teether industry. Any of these shapes maybe employed. On the other hand, mouth portion 16 can also be smooth and unornamented, if desired.

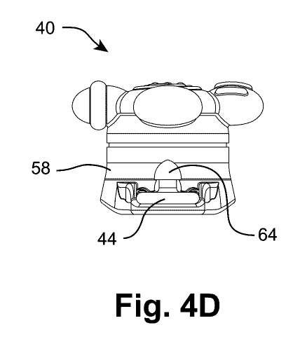

Similarly, face shield or faceplate 14 may have ornamentation 24 on it, typically on the side nearest to the infant's face. The nature of the ornamentation is not important to the present invention and may take the form of any desirable shape. It may contain one or more through holes or apertures 21 for receiving a strap such as strap 44 of FIG. 4. Similarly, the outline or periphery of faceplate 14 may take any shape desired. Its primary function is to ensure that the infant does not swallow the entire pacifier 10 and choke. Therefore, the faceplate 14 should be larger than the mouth of the intended user and the height or distance of mouth portion 16 from face plate 14 should be 35 mm or less.

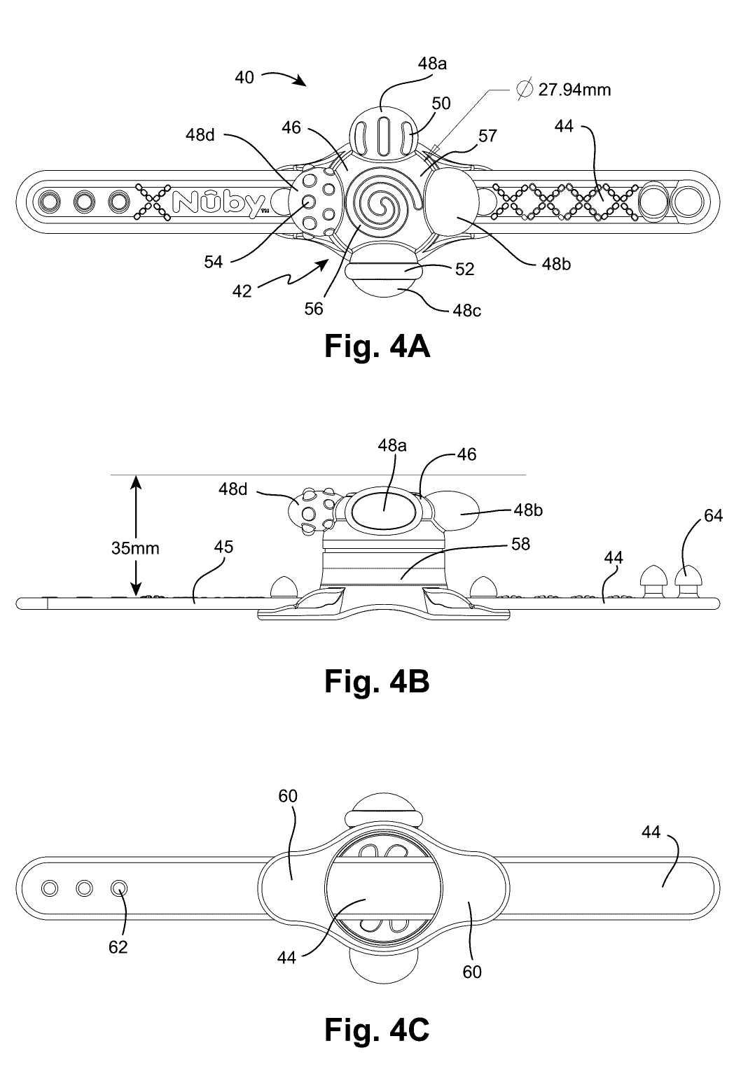

Housing 18 as shown in this embodiment has a diameter similar to that of mouth portion 16 and extends on the handle side of faceplate 14 in one embodiment but generally opposite mouth portion 16. Housing 18 can be used to contain various functional components that provide the vibration and control of the device such as those described in connection with FIGS. 2 and 3. In an alternative embodiment, switch or user input 19 is adapted to receive and transmit user commands to a controller 36 of FIG. 3. In another embodiment, user input 19 activates switch 28 of FIG. 2.

FIG. 2 shows these illustrative components in schematic form. Illustratively, the operational components used in these preferred embodiments include a sensor 26 that is coupled to a switch 28. Illustratively, switch 28 is in circuit with a battery 30, a timer 32, and a vibrator motor 34. Alternatively, a printed circuit board includes sensor 26, a power source or battery 30, a timer 32, a switch or controller 28 and a vibrating motor or vibrator 34. The specific configuration can be varied, and some of the components may be combined, as is convenient for the manufacturer. For example, the switch may be integrated with the timer. Or, the sensor and switch can be one device.

The sensor 26 may be of a mechanical type so that when the user bites down or sucks sufficiently on mouth portion 16, she actuates the sensor 26. Preferably, sensor 26 is a microphone that senses vibrations more subtle than a biting or sucking action. Sensor 26 actuates switch 28 which actuates a timer 32 to provide power to a vibrator motor 34. The power comes from a battery 30, typically a small dry cell or lithium button battery that is attached to the printed circuit board by a battery holder. Once actuated, timer 32 provides power for a measured period of time, such as 5-10 seconds, and then turns off. Thus, vibrator motor 34 operates for the amount of time prescribed by timer 32. During the time that vibrator motor 34 is vibrating, the vibrations are mechanically coupled to the mouth portion 16 where they can be felt by the infant user. After the vibrations stop, the infant must reactivate the switch 28 by biting or sucking on the mouth portion 16 in a manner sufficient to actuate sensor 26.

Sensor 26 maybe a simple apparatus located centrally within mouth portion 16. Indeed, the entire switch 28 could be embodied within mouth portion 16 and no sensor 26 would be required. An alternative embodiment can operate on fluid pressure so that squeezing down on the mouth portion 16 compresses air or a liquid contained within mouth portion 16 and this exerts pressure on a sensor 26 associated with switch 28. Various arrangements and configurations of a switch and/or sensor can be used within the scope of the present invention. It is necessary merely that a switch be provided that can be actuated by either the infant user or her caretaker.

Alternatively, in another embodiment, the switch could be activated simply by shaking the entire pacifier 10, if desired. It can thus be motion sensitive in general.

In another embodiment, a switch or user input 19, FIG. 1A-1, can be provided that is not responsive to biting or sucking but simply is turned on or activated by the caretaker of the child so that the timer and vibrator automatically cycle on and off according to a prescribed duty cycle and continue in this fashion until the switch is turned off by the caretaker, or a timer may stop it after a longer time, illustratively five minutes. In some embodiments, the vibration is provided for a predetermined duration when the switch is activated by the child. In another embodiment, the teether may have multiple time settings that can be set before the teether is given to the child. In one embodiment, the switch or user input receives and transmits signals to the controller for controlling the operation of the device.

Vibrators such as vibrator motor 34 are well known to the industry. Illustratively, vibrator motor 34 may take the form of a vibrating mini motor disc such as Product 1201 from Adafruit. That product has a 10 mm diameter, is 2.7 mm thick, and runs on 2-5 volts. These vibrator products are also sometimes referred to as micro vibration motors or micro flat button coin vibration motors. They also are often called “Haptic motors.” Haptic motors are used for buzzers and vibration motors and are used, for instance, in cell phones. A manufacturer may also include a motor controller to provide various effects relating to the vibration. One example would be the Adafruit DRV2605L Haptic Motor Controller, product ID 2305, which has the ability to ramp the vibration level up and down, provide click effects, different buzzer levels, or other interesting effects. The vibrator motor 34 is mounted on the housing so that the device, or at least the mouth portion 16, is caused to vibrate when vibrator motor 34 is activated. Alternatively, vibrator motor 34 may be mechanically connected directly to the mouth portion 16. In mentioning a vibrator motor 34, I do not intend to exclude other types of vibration-providing devices that might not be considered “motors.” Any controllable vibration-causing apparatus may be used within the scope of the present invention.

FIG. 3 shows another arrangement of operational components within housing 18. This may include a sensor 26 coupled to a motor controller 36 that is coupled to battery 30 and vibrator motor 34. In an alternative embodiment, switch or user input 19 of FIG. 1A-1 is adapted to receive and transmit user commands to controller 36.

FIGS. 4A-D show various views of an embodiment of a teether on a wristband. FIG. 4A shows a top view thereof. FIG. 4B shows a side view. FIG. 4C is a bottom view, and FIG. 4D is an end view. These figures show an oral comfort device 40 having a teether 42 and a wristband 44. Teether 42 includes a central portion 46 from which four distinct lobes 48a-d extend radially outward. As is common in teethers, the use of lobes 48 may be relatively unornamented, as in 48b, or may have projecting ridges 50 as shown on lobe 48a, a single broad ridge 52 as shown on lobe 48c, or a plurality of upstanding bumps 54 as shown on lobe 48d. Various ones of these structures are found to be efficacious in relieving the pain of teething in infants. A central design, illustratively a spiral 56 on top surface 57 of central portion 46, can be included on the central portion 46. Preferably, these features are molded into the teether 42, and no portion of the teether is removable by the infant. Preferably, teether 42, to the extent it may be mouthed or engorged by the infant, is made of silicone or some other suitable compressible material of the type ordinarily used in teething rings for other teethers. Preferably, teether 42 must be at or below 35 mm as measured from top surface 57 to the top of strap surface 45.

Teether 42 includes a housing 58 underneath the central portion 46, as seen in FIG. 4B for example. Housing 58 preferably includes the switch 28, battery 30, timer 32, and vibrator motor 34. Each lobe 48a-d of the teether may include its own sensor for the switch 28. Central portion 46 may also include a sensor for the switch. Such sensors illustratively may operate in response to pressure applied by the infant biting a portion of teether 42. An alternative or additional sensor may be positioned between an upper portion of the teether (that includes the lobes and central portion) and, on the other hand, housing 58 so that the infant can actuate the switch simply by pushing on the upper portion of the teether. In other words, as an alternative to biting a lobe, or in addition to such biting, the vibrator motor 34 may be activated if the infant draws the wristband product 40 to her face and applies pressure on the teether portion 42 to push it toward the wristband 44. Of course, such a sensor or switch could also be activated by tapping the top of the teether 42 even before it is in position to be inserted into the mouth. As with the earlier-described embodiment, the vibrator motor 34 is mounted on the housing 58 so that teether 42, or at least its mouth portions (lobes 48a-d), are caused to vibrate when vibrator motor 34 is activated. Alternatively, vibrator motor 34 may be mechanically connected directly to the central portion 46, one or more of the lobes 48, or otherwise.

Preferably wristband 44 is made of silicone or some similar flexible substance. The teether 42 can be molded onto the wristband 44 or can be detachable from it. Illustratively, guides or sleeves 60 are provided as seen in FIG. 4C so that the wristband 44 can be inserted through longitudinal openings in guides 60. The wristband may include holes 62 on one lateral side into which a suitable closure pin 64 positioned on the opposite lateral side may be inserted to encircle the child's wrist. The closure pin 64 may include a broadened head on it to retain the pin in the hole 62.

Thus, the embodiment shown in FIGS. 4A-4D provides a wristband that allows the teether to be attached to a child's wrist. The wristband allows the child to bring the teether to her mouth without having to grasp the teether with her hands. This feature allows the teether to be used by a child who is unable to grasp the device—for example, very young infants before they develop the coordination to grasp objects. It also allows the child to teethe while retaining another object or objects in her hands. As handheld teethers and pacifiers are frequently dropped by children and subsequently lost, the wristband feature minimizes the likelihood of loss of or damage to the invention. It is contemplated that a pacifier may be wrist-mounted within the scope of the present invention.

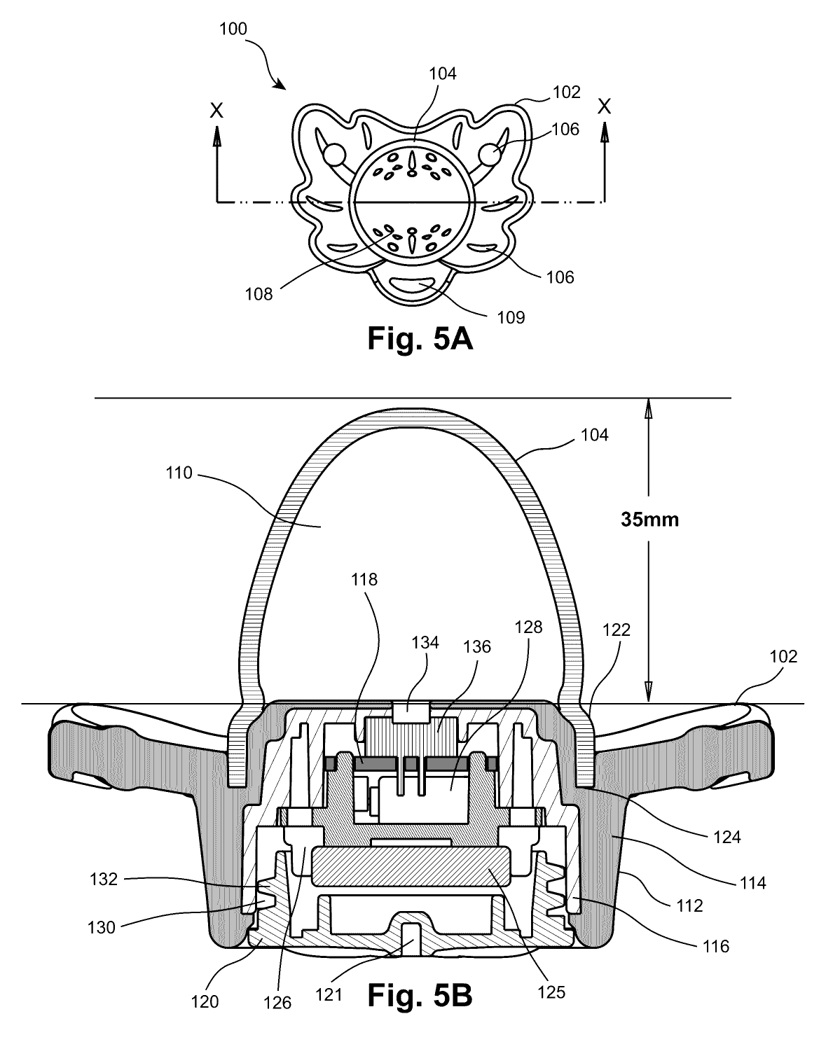

FIG. 5A is a top view of a component suitable for use in an embodiment of the oral comfort device of the present invention. Oral comfort device 100 is shown as a standalone pacifier or teether without handle 12 or strap 44. Oral comfort device 100 is shown with shield or face plate 102 having ornaments 106. Attached to face plate 102 is mouth portion 104 having ornaments 108. Mouth portion 104 can be a teether or a pacifier such as a nipple or teat. Face plate 102 may be adapted with aperture 109 for receiving strap 44 of FIG. 4A-C or other suitable holder.

FIG. 5B is a cross sectional view of the component shown in FIG. 5A along the line X-X. Mouth portion 104 is shown formed of a pliable material such as silicone forming a cavity 110. In the preferred embodiment, the silicone forming mouth portion 104 has a Durometer of 20-30°. Mouth portion 104 has tongue 122 seated in groove 124 and fixed to housing 112, preferably by a silicone adhesive such as RTV sealant, so that a liquid tight seal is formed between mouth portion 104 and housing 112. Housing 112 comprises a shell 114 formed of silicone around base ring 116. Base ring 116 is preferably formed of nylon. Fixed inside base ring 116 is circuit board 118. Attached to circuit board 118 are microphone switch 136, battery 125 and battery holder 126 and vibrator 128. In the preferred embodiment battery 125 is a silver oxide or lithium button cell battery. Microphone switch 136 may perform the functions provided by sensor 26 and switch 28 in FIG. 2 or sensor 26 in FIG. 3. Microphone switch 136 is coupled to cavity 110 through opening 134. Movement of mouth portion 104 creates a vibration that is sensed by microphone switch 136 which then can either activate vibrator 128 (vibrator motor 34, FIG. 2) or send a signal to motor controller 36 (FIG. 3). Cap 120 has cap threads 132 removably fixing cap 120 to compatible base threads 130 of base ring 116. Cap 120 is fastened and removed from base ring 116 by inserting a coin or screw driver (not shown) in screw tab 121 and twisting. In the preferred embodiment cap 120 is constructed of nylon. In the preferred embodiment, shell 114 is fixed over base ring 116. In the preferred embodiment shell 114 is constructed of silicone having a Durometer of 50°. In the preferred embodiment the distance from mouth portion 104 to face shield 102 is 35 mm or less.

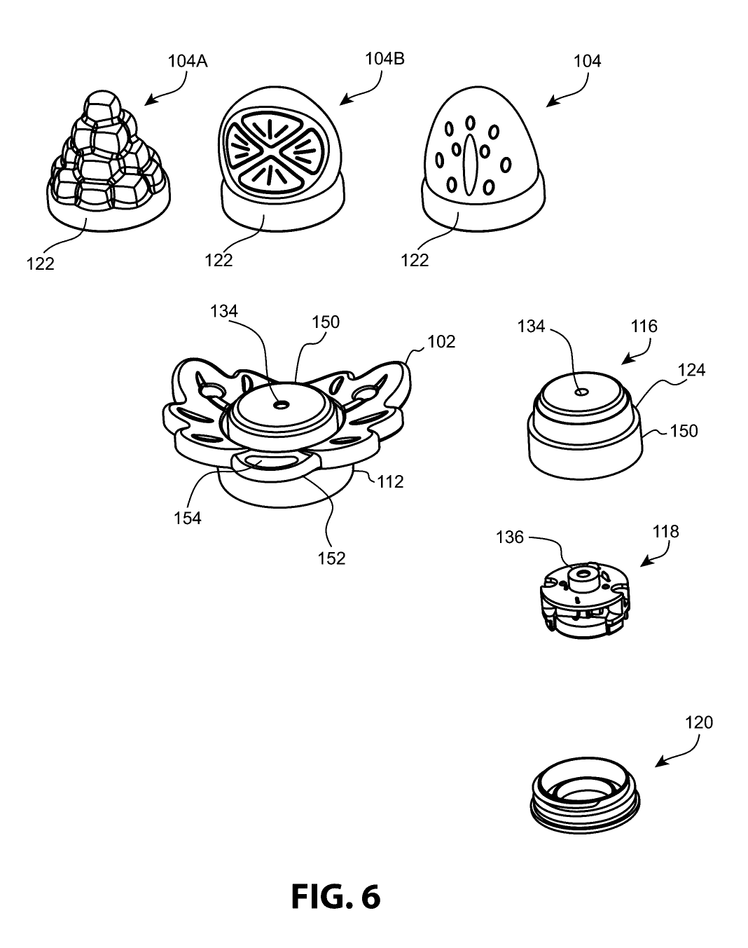

FIG. 6 is an exploded perspective view useful in illustrating a method for assembling an embodiment of the oral comfort device of the present invention. Three alternative mouth portions 104A, 104B and 104C are shown with various examples of surface ornamentation. Mouth portion 104 is fixed to housing 112. Tongue 122 of mouth portion 104 is fitted to groove 124 along seat 150 of housing 112. Housing 112 is shown with tab 152 having an aperture or strap opening 154 suitable for receiving a strap 44 such as that shown in FIGS. 4A-4D or other suitable holder. Base ring 116 is either press fit or over molded with an elastomeric material such as silicone to form housing 112. Printed circuit board 118 is placed inside base ring 116 which is sealed with cap 120. Aperture 134 in base ring 116 aligns with microphone switch 136, FIG. 5B.

Referring to FIG. 6 a method of assembling a vibrating oral comfort device is described. Base ring 116 and cap 120 are constructed from nylon. Printed circuit board 118 is constructed having components including a sensor, a battery holder, a vibrator and controller. Printed circuit board 118 including its components is attached to base ring 116. Shell 114 is formed of silicone and is adapted to receive base ring 116. Base ring 116 is coated with an adhesive and then press fit into shell 114 to form housing 112. Separately mouth portion 104 having tongue 114 is formed of silicone. Mouth portion 114 is fixed to housing 112 using an adhesive and forms a liquid tight seal between mouth portion 114 and housing 112. Cap 120 is then attached to base ring 116 of housing 112 to seal printed circuit board 118 and its components inside housing 112.

It will be appreciated that wide variations in the specific configuration of the oral comfort device, whether a pacifier or teether, may be made. Instead of a central portion from which lobes extend outward, the teether may take the form of animals, amphibians, fish, reptiles; various items from the plant world such as a flower, grape cluster, strawberry-shape, or various inanimate objects like a locomotive, automobile, etc. Or, as shown in FIGS. 4A-4D, a fanciful shape of any sort can be used in implementing an oral comfort device capable of vibrating.

From the foregoing discussion, persons skilled in the art will understand that numerous modifications and variations can be effectuated without departing from the spirit and scope of the present invention. It is to be understood that no limitation with respect to the specific embodiments illustrated is intended or should be inferred. The present invention is intended to be covered by the appended claims, including all such modifications as fall within the scope of such claims.

What is claimed is:

1. A vibrating child's oral comfort device comprising:
a strap suitable for attaching to the wrist of a child;
a mouth portion of a size suitable for partial or full insertion into the mouth of a child;
a housing impervious to liquid having a body and a removable cap, the housing adapted to couple the mouth portion to the strap and to contain a sensor associated with the mouth portion, a removable power source, a vibrator operatively coupled to the mouth portion, and a controller having an input from the sensor and an output for driving the vibrator.

2. The device of claim 1 wherein the controller further comprises a timer for controlling the duration of operation of the vibrator.

3. The device of claim 1 wherein the sensor is a microphone.

4. The device of claim 1 wherein the strap, mouth portion and housing are constructed of silicone.

5. The device of claim 1 wherein the housing further comprises a ring adapted to receive the removable cap and a printed circuit board for mounting the sensor, the power source, the vibrator and the controller.

6. The device of claim 1 wherein the housing is removably attached to the strap.

7. The device of claim 1 wherein the mouth portion is a teether and is compressible by a user.

8. The device of claim 1 wherein the mouth portion is a teether having a textured surface.

9. The device of claim 1 further comprising a face plate fixed to the housing, and a distance between the face plate and a top of the mouth portion is less than 35 mm.

10. The device of claim 1 wherein the housing further comprises a base ring and the removable cap and base ring are constructed of nylon.

11. The device of claim 1 wherein the housing further comprises a user input adapted to receive and transmit user commands to the controller.

12. A method for assembling a child's vibrating oral comfort device comprising;
constructing a base ring of nylon;
attaching to the base ring a printed circuit board having a sensor, a battery holder, a vibrator and a controller,
molding a silicone shell and inserting the base ring into the silicone shell to form a housing;
attaching a cap to the base ring;
constructing a mouth portion of silicone; and
fastening the mouth portion to the housing.

13. The method of claim 12 including the step of attaching a battery to the battery holder.

14. The method of claim 12 wherein the mouth portion is fastened to the housing with an adhesive to form a liquid tight bond.

15. The method of claim 12 wherein the housing is removably attached to a strap.

16. A child's vibrating oral comfort device comprising:
a housing having a base, a cap and a face plate;
a mouth portion of a size suitable for partial or full insertion into the mouth of a child, the mouth portion fixed to and extending away from the housing face plate and positioned so that a child may put the mouth portion into the child's mouth;
a printed circuit board fixed to the housing base and having a sensor arranged to detect pressure applied to the mouth portion, a power source holder, a vibrator operatively coupled to the mouth portion, and a controller responsively coupled to the sensor and controllingly coupled to the vibrator to control an aspect of its operation.

17. The device of claim 16 wherein the housing has an outer shell constructed of silicone and is fixed around the base leaving an opening for receiving the removable cap.

18. The device of claim 16 wherein the mouth portion is constructed of silicone.

19. The device of claim 16 wherein the sensor senses pressure.

20. The device of claim 16 further comprising a user input adapted to receive and transmit user commands to the controller.
